(19) United States
(12) Patent Application Publication
(10) Pub. No.: US 2011/0252662 A1
(43) Pub. Date: Oct. 20, 2011

(54) MINERAL SLURRY DRYING METHOD AND SYSTEM

(76) Inventors: Richard W. Bland, Beckley, WV (US); Bruce McDaniel, Midlothian, VA (US)

(21) Appl. No.: 13/168,169

(22) Filed: Jun. 24, 2011

Related U.S. Application Data
(63) Continuation-in-part of application No. 12/924,570, filed on Sep. 30, 2010.
(60) Provisional application No. 61/247,688, filed on Oct. 1, 2009.

(51) Int. Cl. F26B 5/16; F26B 13/26

(52) U.S. Cl. 34/333; 34/334; 34/95

(57) ABSTRACT

The present invention provides a method and system for drying mineral slurry concentrate and high moisture content minerals using activated alumina. The method and system dries the mineral slurry concentrate by combining the slurry with the activated alumina. While in combination, the mixture is agitated to maximize surface contact between the activated alumina and the slurry. As the mineral slurry concentrate contacts the activated alumina, the surfactant moisture on the mineral elements is then absorbed by the activated alumina. The activated alumina allow for the water molecules to be adsorbed by the activate alumina, thus being removed from the slurry elements. After a period of agitation, the method and system thereby separates the activated alumina from the mineral slurry concentrate.

### RELATED APPLICATIONS

The present application is a Continuation-in-part and claims priority to U.S. patent application Ser. No. 12/924,570 filed Sep. 30, 2010 entitled “COAL FINE DRYING METHOD AND SYSTEM” which claims benefit from U.S. Provisional Patent Application Ser. No. 61/247,688 filed Oct. 1, 2009.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The present invention relates generally to remove moisture from mineral slurry and more specifically to drying mineral elements using activated alumina.

### BACKGROUND OF THE INVENTION

In the continued push for cleaner technology trends, a concurrent growth trend is the better mining and utilization of existing mineral resources. As used herein, mining of mineral resources includes not only the extraction from the ground, but also the processing of the resource to extract in its raw or otherwise usable form. The mining of mineral resources follows a complicated process that includes the generation of slurries concentrates having mineral slurries having high moisture content. The slurry contains the important minerals, but needs to be properly separated from the moisture content.

Concentrated mineral slurries have been the subject of dewatering processes for many years. The production includes mineral concentration facilities that produce the mineral slurries, and from these slurries the excess water must be removed to acquire the valuable minerals. The dewatering process endeavors to achieve liquid water removal from the concentrated mineral slurry. A goal of the dewatering process is to decrease the residual liquid water content of the starting mineral slurry concentrate. Dewatering additives such as flocculants in combination with an anionic surfactant have been added to concentrated mineral slurries to reduce the liquid water content of the treated slurry being subjected to filtration. In theory, dewatering aids should increase production rates as well as decrease the amount of water present in the filtered ore or coal cake solids. Because the filtered solids contain less water, the overall production is expected to increase. However, in practice this is not always observed because it produces further requirements of production facility requirements. Traditionally, polymers have been used to agglomerate solids and increase the filtration rate. However, polymers substantially increase the costs. In many instances, the end use or processing of the mineral is detrimentally affected by the higher cost.

There is a need to decrease the cost of the production of minerals, rather than a volume of product. Elimination of the moisture in the filter cake or centrifuge solids increases the amount of mineral or ore solids on a weight percent basis, thereby reducing freight costs required for transport or energy costs for further drying or processing per kilogram of the mineral, or ore solids.

Thus, it is known by those skilled in the art that generally when the moisture content of an aqueous mineral slurry concentrate is beneficially reduced by use of certain additives, a disadvantage also occurs in that the production of the resulting filter cake is decreased at the expense of achieving the beneficial dewatering. None of the background art processes have addressed both the need to reduce the residual liquid water content of the concentrated mineral slurry while simultaneously increasing the production of the mineral concentrate filter cake that results from the water removal process such as for example but not limited to a filtration process.

U.S. Pat. No. 4,207,186 (Wang '186) provides a process for dewatering mineral and coal concentrates comprising mixing an aqueous slurry of a mineral concentrate and an effective amount of a dewatering aid that is a combination of hydrophobic alcohol having an aliphatic radical of eight to eighteen carbon atoms and a nonionic surfactant of the formula R—(OCH.sub.2CH.sub.2).sub.xOH wherein x is an integer of 1-15, R is a branched or linear aliphatic radical containing six to twenty-four carbon atoms in the alkyl moiety, and subjecting the treated slurry to filtration. Wang et al. '186 states that when a hydrophobic alcohol such as decyl alcohol is combined with a nonionic surfactant, lower moisture contents are obtained with iron ore concentrate than had a dewatering aid not been employed. Wang et al. '186, however, is unconcerned with increasing the production of the resulting filter cake.

U.S. Pat. No. 4,210,531 (Wang '531) provides a process for dewatering mineral concentrates which consists essentially of first mixing with an aqueous slurry of a mineral concentrate an effective amount of a polyacrylamide flocculant, and next mixing with the flocculant-treated slurry an effective amount of a combination of an anionic surface active agent composition and a water insoluble organic liquid selected from aliphatic hydrocarbons, aromatic hydrocarbons, aliphatic alcohols, aromatic alcohols, aliphatic halides, aromatic halides, vegetable oils and animal oils, wherein the water-insoluble organic liquid being different from any water-insoluble organic liquid present in the anionic surface active agent composition, and thereafter removing the water as a liquid from the slurry. Wang et al. '531, however, does not address and is unconcerned with reducing the residual liquid water content of the concentrated mineral slurry and increasing the production of the resulting filter cake, nor does it address the expanded costs because of added production requirements.

Additionally, there are fundamental differences in the drying of techniques Wang '186 and Wang '531 because these techniques relate to the drying of coal. The coal drying techniques are different because of the mineral elements of the mineral slurry, as well the origination of the drying process being applied to the mineral slurry concentrate versus coal.

Concurrently, there are known technologies called molecular sieves, including the co-pending patent application Ser. No. 12/924,570 providing for the application of molecular sieves to coal fines. Similar to the shortcomings of Wang '186 and Wang '531 to coal, similar differences exist between the application of molecular sieves to coal fines versus mineral slurry concentrate having mineral slurry contained therein. In addition to the higher starting moisture content of the mineral slurry compared with coal fines, there is also a different moisture distribution between surface moisture and inherent moisture. There are also differences in physical properties of the material science of mineral slurry compared with coal fines, including differences for the processing of the dewatering techniques as described in further detail below. Moreover, there are cost limitations with molecular sieves.

Relative to mining, existing mineral slurry dewatering techniques have limited benefits with large environmental concerns. As such, there exists an economical need for a method and system for drying mineral slurries to reduce the moisture content, thereby improving the harvest of minerals and reducing environmental impact.

### SUMMARY OF THE INVENTION

The present invention provides for a reduction in the residual liquid water content of the concentrated mineral slurry while also providing for an increased production of the filter cake that results from the water removal process, as well as a process for performing dewatering mineral slurry concentrate in a continuous flow operation.

The present invention provides a method and system for drying a mineral slurry concentrate using activated alumina. The method and system dries the slurry using any number of known techniques, but may also be performed by combining the slurry concentrate with the activated alumina using the techniques described herein. While in combination, the mineral slurry concentrate and activated alumina mixture is processed to reduce the concentrate moisture, and to maximize surface contact between the activated alumina and the mineral slurry concentrate. As the slurry concentrate contacts the activated alumina, the surfactant moisture on the slurry is then absorbed by the activated alumina. The activated alumina allow for the water molecules to pass into them, thus being removed from the slurry. After a period of agitation, the method and system thereby separates the activated alumina from the slurry.

The method and system may use additional techniques for adjusting the volume of mineral slurry concentrate and/or activated alumina, as well as or in addition to adjust the agitation to maximize the percentage of moisture removal. The method and system may also dry the activated alumina to remove the extracted moisture and thus re-use the activated alumina for future moisture removal operations. The method and system may operate to allow further processing of the mineral slurry concentrate after separation from the activated alumina.

Thereby, the method and system improves moisture reduction of mineral slurry concentrate by allowing for the removal of moisture using activated alumina. The utilization of activated alumina significantly reduces processing inefficiencies and costs found in other processing techniques, as well as being environmentally friendly by reducing environment by-products from existing dewatering techniques as well as reducing energy needs for prior heating/drying techniques.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates one embodiment of a system for drying mineral slurry;

FIG. 2 illustrates a flowchart of steps of one embodiment for drying mineral slurry;

FIG. 3 illustrates another embodiment of a system for drying mineral slurry; and

FIG. 4 illustrates a flowchart of steps of another embodiment for separating the moisture from the minerals in the mineral slurry.

### DETAILED DESCRIPTION

In the following description, reference is made to the accompanying drawings that form a part hereof, and in which is shown by way of illustration specific embodiments in which the invention may be practiced. It is to be understood that other embodiments may be utilized and design changes may be made without departing from the scope of the present invention.

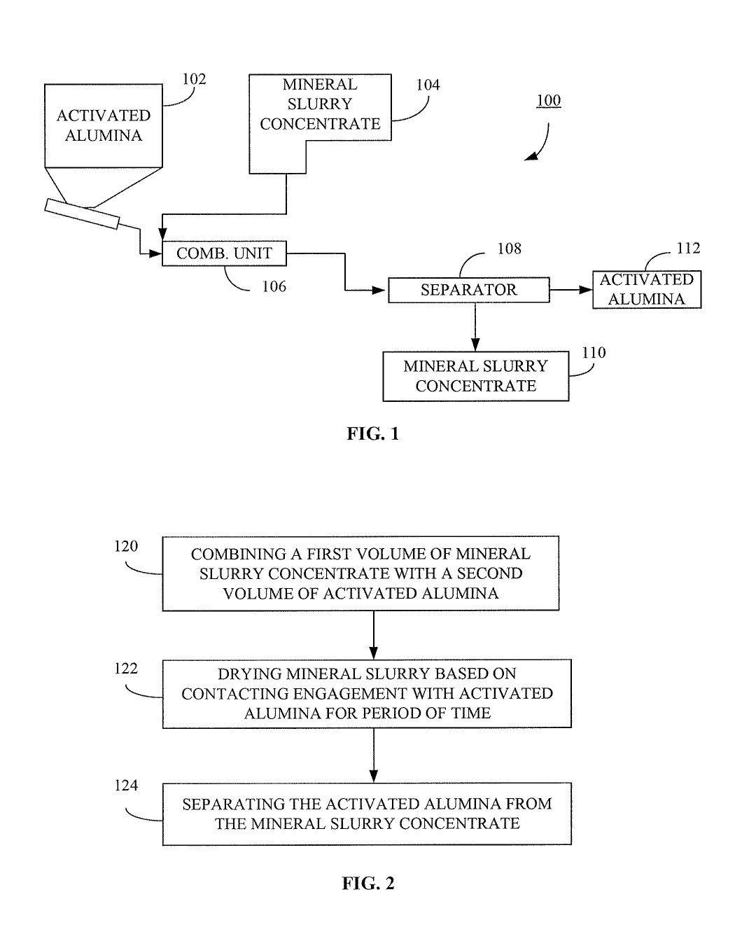

FIG. 1 illustrates one embodiment of a system 100 for drying mineral slurry concentrates. The mineral slurries may be any number of suitable types of slurry, including but not limited to iron ores, copper ores, combinations thereof, salts, oxides and sulfides, magnetite iron ore, and can include materials such as molybdenum, nickel, zinc ore, platinum group metals, sand, gravel and others. The system 100 is operative to function within the larger context of mineral processing. The system 100 operates at the slurry level for the reduction of moisture in the slurry, once the mineral has been reduced to a particular size, such as for example, but not expressly limited to, a size of 28 mesh to zero.

The operations prior to the system 100, including the generation of the slurry, are well known to those in the art and are omitted for brevity purposes only. Similarly, processing operations occurring after the moisture reduction operations described herein are also well known in the art, being omitted herewith also for brevity purposes only.

In the illustrated embodiment of FIG. 1, the system 100 includes an activated alumina distribution unit 102, a mineral slurry concentrate distribution unit 104, a combination unit 106 and a separator 108. From the separator 108 are dispersed mineral slurry concentrate 110 and activated alumina 112.

The system 100 operates to remove moisture from mineral slurry concentrate by having the activated alumina in contacting engagement with the concentrate. The material science of the activated alumina allow for the adsorption and/or absorption of the surfactant moisture on the mineral slurry concentrate. By facilitating surface area contact between the activated alumina and the mineral slurry, the moisture is then transferred from the minerals in the concentrate to the activated alumina. In the embodiment of activated alumina, the water molecule may be encapsulated into the beads, thus removed from the mineral of the mineral slurry.

Based on sizing differences between the activated alumina and the mineral slurry elements, the slurry may be readily separated from the activated alumina. Thereby, once the separation occurs, the remaining slurry has a reduced moisture content level.

The described techniques overcome the problems associated with the prior techniques of removing moisture because it eliminates the need for energy-intensive drying operations and does not generate any airborne particulates common with heat-based drying techniques and energy intensive and chemical intensive non-thermal techniques.

It is recognized that molecular sieves may be utilized in alternative embodiments, but structural limitations of the zeolites can dictate adjustments of the drying process to account for the physical limitations of these beads, such as for example having to reducing the processing speed because of molecular sieve degradation and thus causing increased production costs for the utilization of new sieves. Co-pending U.S. patent application Ser. No. 12/924,570 describes the drying process using molecular sieves. These embodiments provide for the removal of surfactant moisture, but improved moisture removal is realized based on the utilization of activated alumina over the molecular sieves. Molecular sieves, are by their very nature, zeolites having a microporous composition whereby water molecules having the associated size are able to fit into the pores of the sieve and the molecules of the corresponding material being dried (e.g. mineral slurry) cannot. Material limitations of the molecular sieves complicate the continuous drying process, including for example maintenance of the structural integrity of the molecular sieve as it is processed through the continuous flow operation. By contrast, activated alumina particles or beads have a hydroxyl surface that attracts and drives material to stick to the surface, compared with molecular sieves that use micropores to allow moisture to pass therethrough. Chemically, compositionally and functionally, activated alumina are different from molecular sieves and improve moisture removal capacities of the present embodiments. Molecular sieves are exclusionary elements to filter or otherwise selectively reduce a particular chemical element in a mixture based on the manufacturer openings in the sieve itself, such that the functionality and usability of the molecular sieve is dictated by the opening sizes of the pores in the sieves compared with the known adsorption properties of the activated alumina.

The activated alumina distribution unit 102 includes a plurality of activated alumina. Some activated alumina can adsorb water up to 30% of their dry weight. Activated alumina is manufactured from aluminium hydroxide by dehydroxylating it in a way that produces a highly porous material; this material can have a surface area significantly over 200 square meters/g. It is made of aluminium oxide (alumina; Al2O3). It has a very high surface-area-to-weight ratio. That means it has a lot of very small pores, almost like tunnels that run throughout it, and through this composition the activated alumina allows for the adsorption of moisture from the mineral slurry concentrate. In other embodiments, activated alumina may be selected from any other suitable material(s) recognized by one skilled in the art such that the activated alumina is operative to perform the adsorption or absorption properties described herein.

While the present embodiment is described herein using activated alumina, it is recognized that other types of desiccants can be utilized and employed in the drying of the mineral slurry, including for example molecular sieves.

Activated alumina with pores large enough to draw in water molecules, but small enough to prevent any of the mineral slurry mineral elements from entering the sieves, can be advantageously employed. Hardened activated alumina also provide the benefit of not breaking down as easily and are readily re-usable once the absorbed water is removed, as described below. In another embodiment, the activated alumina may include magnetic properties for separation of the mineral using magnetic forces, if applicable. As used and described herein, activated alumina is not limited to beads or particles having a chemical composition composed exclusively of activated alumina, but rather it is recognized that the term activated alumina includes any particle or bead having at least 51% composition of activated alumina. The activated alumina may include additional compositional elements within the particles or beads, including for example other chemicals or molecular structures allowing for the improved moisture absorption and/or adsorption described herein, as well as the application of other functional benefits. For example, the activated alumina may include magnetic elements such that the particles or bead has magnetic properties allowing for the use of the magnetic properties during the separation phase to separate the mineral slurry from the beads. While it is recognized that the mineral slurry elements include existing magnetic properties complicating magnetic separation, varying degrees of magnetic attraction may be developed and employed to facilitate the corresponding separation process, in one embodiment.

In some embodiments activated alumina particles are greater than 1, 1.25, 1.5, 1.75, 2.0, 2.25 or 2.5 mm in diameter and less than about 12.5 mm. When mixed with the mineral slurry having excess moisture, the activated alumina quickly draw the moisture from the slurry. Based on different properties, the mineral slurry and the activated alumina can be separated using different possible techniques. For example, as the sieves are larger than the slurry elements (e.g., over a millimeter in diameter), the mixture of sieves and slurry elements can be lightly bounced on a fine mesh grid, where the slurry can be separated from the activated alumina. Another example can take advantage of magnetic properties of the slurry, such as using one or magnetic means to separate the sieves from the slurry.

The mineral slurry distribution unit 104 has mineral slurry stored therein. In a typical operation, the distribution unit 104 receives mineral slurry in a process operation using known processing techniques to generate the mineral slurry from the mined minerals. Physical properties of the slurry itself may dictate limitations of the flow rates of the mineral slurry, as well as the rates for distribution by the unit 104, where the slurry includes the mineral components, additive components that might be added as part of the refining process and moisture content. In one embodiment, the elements of the mineral slurry may be between the sizes of 28 mesh to zero, wherein the 28 mesh to zero is an exemplary sizing descriptor, but not as a limiting dimension utilized herein.

The combination unit 106 may be any number of possible devices for combining the activated alumina and mineral slurry. The combination unit 106 includes functionality for the contacting engagement of the mineral slurry with the activated alumina, plus some degree of agitation. As noted above, the activated alumina operate by removing surfactant moisture, therefore the agitation of the combined mixture of activated alumina and mineral slurry increases the surface area contact therebetween.

For example, in one embodiment the combination unit 106 may be a circular tube having a circular channel through which the combined mixture of mineral slurry and activated alumina pass. This circular tube may be rotated at a particular speed and the tube extended for a particular distance so the mineral slurry and activated alumina are engaged for a certain period of time. The amount of moisture removal is dictated, in part, based on the length of the engagement of the mineral slurry and activated alumina, as well as the amount of agitation. Drying optimization provides for determining the proper amount of engagement for drying the mineral slurry to the right moisture content, which is dependent upon many factors, including the incoming mineral slurry moisture level, the volume of the activated alumina, the degree of agitation, etc. As described in further embodiments below, additional feedback can be implemented to adjust the combination unit 106 and thus adjust the moisture level of the mineral slurry. In one embodiment, but not a limiting range, the mixing tonnage may have a combination range between 4 parts activated alumina to 1 part mineral slurry to 1 part activated alumina to 1 part mineral slurry, depending on the desired moisture content of the final product.

Another embodiment of the combination unit 106 may be an agitation device or other platform that includes vibration or rotation to cause surface area contact between the mineral slurry and the activated alumina. Additional embodiments of the combination unit 106, as recognized by one skilled in the art, may be utilized providing for the above-described functionality of facilitating contacting engagement between the mineral slurry and the activated alumina.

Additional embodiments of agitators may include internal rotor mixers, continuous mixers, blenders, double arm misers, planetary mixers, ribbon mixers and paddle mixers. Based on the various characteristics of the desiccant and the mineral slurry concentrate, different mixer embodiments provide varying degrees of moisture removal. The various types of mixers allow for customization of the agitation of activated alumina and mineral slurry concentrate for moisture reduction, as well as processing for the re-usability of the desiccant in the continuous flow process.

The separator 108 may be any suitable separation device recognized by one skilled in the art. The separator 108 operates using known separator techniques, including for example in one embodiment vibration and vertical displacement. The separator 108 operates by, in one embodiment, providing holes or openings too small that the activated alumina beads will not pass through, but the slurry elements readily pass therethrough. For example, one embodiment may include a high frequency, low amplitude circular or elliptical screen for filtering the mineral slurry from the activated alumina. In another embodiment, the separator 108 may include magnetic means taking advantage of the magnetic properties of the slurry elements and/or activated alumina.

Once separated, the activated alumina can be passed to a dryer where they can be dried and sufficient moisture is removed to permit their reuse if desired. Thus, the activated alumina can be employed in a close-loop system, where they are mixed with the mineral slurry, and after removing water/moisture (drying) they are separated from the mineral slurry and passed through a dryer and reused.

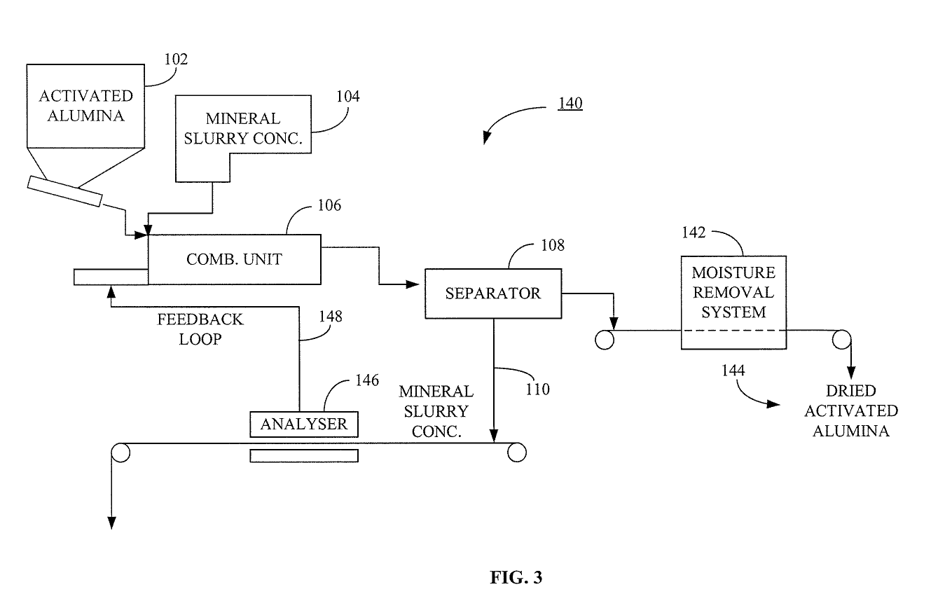

For the sake of brevity, one embodiment of the operations of the system 100 is described relative to the flowchart of FIG. 2. The flowchart of FIG. 2 illustrates the steps of one embodiment of a method for processing and/or drying mineral slurry. The method includes the step, step 120, of combining a first volume of mineral slurry with a second volume of activated alumina. With respect to the system 100 of FIG. 1, the activated alumina are dispensed from the activated alumina distribution unit 102 and the mineral slurry is dispensed from the mineral slurry distribution unit 104.

By way of example, and not meant as a limiting measurement, one embodiment may include 1,500 pounds per hour of activated alumina per ton of mineral slurry per hour. These volumes are exemplary for a continuous flow drying operation as described in further detail below. In this example, the first volume and second volume are relative to flow rates for the corresponding elements. The flow rate may be dependent upon mineral slurry feed rates, as well as the corresponding available volume in the combination unit. By way of example, a drying operation may seek contact time of 2 minutes and the mineral slurry feed rate is 100 tons per hour, the feed rate may be 3,333.33 pounds of per minute of mineral slurry. A mixture ratio of activated alumina to mineral slurry may be 75 tons per hour activated alumina to 100 tons per hour mineral slurry with a pounds per minute rate of 5,833.33. Under this example, that would require approximately 1,500 pounds of activated alumina per ton of mineral slurry per hour.

The activated alumina distribution unit 102 releases a predetermined volume of activated alumina at a predetermined rate. This volume of sieves is in proportion to the volume of mineral slurry. Both units 102 and 104 dispense the corresponding elements into the combination unit 106. One embodiment may rely on gravity to facilitate distribution, as well as additional conveyor or transport means may be used to direct the elements from the distribution units 102 and 104 to the combination unit 106. For example, one embodiment may include conveyor belts to move the mineral slurry and/or activated alumina into the combination unit 106.

Once the combination unit 106 has the volumes of activated alumina and mineral slurry, the next step of the method of FIG. 2 includes drying the mineral slurry based on contacting engagement of the activated alumina and the mineral slurry. As described above, the activated alumina adsorb and/or absorb surfactant moisture from the mineral elements in the mineral slurry, where this is facilitated by the agitation of the combination unit 106. In the example of a rotation assembly, the combination unit 106 may include channels through which the combined activated alumina and mineral slurry pass, the assembly being rotated at a predetermined speed. The speed and length of the channels controls the time in which the activated alumina and mineral slurry are in contact, which directly translates into the corresponding moisture level of the mineral slurry after separation.

After the agitation of mineral slurry and activated alumina in the combination unit 106, the mixture is passed to the separator 108. In one embodiment, a conveyor belt or any other movement means may be used to pass the mixture to the separator 108. In the methodology of FIG. 2, a next step, 124, is separating the activated alumina from the mineral slurry. This step is performed using the separator 108 of FIG. 1. From the separator are split out the mineral slurry 110 and the activated alumina 112. In this embodiment, the method of dying mineral slurry takes mineral slurry from the distribution unit 104, combines them with activated alumina, wherein moisture is then removed, and then the mineral slurry are separated from the activated alumina. The remaining product of this drying method are mineral slurry 110 having a reduced moisture content level and activated alumina 112 containing the extract moisture.

FIG. 3 illustrates another embodiment of a system 140 for drying mineral slurry. This system 140 of FIG. 3 includes the elements of the system 100 of FIG. 1, the activated alumina distribution unit 102, the distribution unit 104, the combination unit 106, the separator 108 and the separated mineral slurry 110 and activated alumina 112. The system 140 further includes a moisture removal system 142 and dried activated alumina 144, as well as a moisture analyzer 146 with a feedback loop 148 to the combination unit 106.

The moisture removal system 142 is a system that operates to remove the moisture from the activated alumina 112. In one embodiment, the system 142 may be a microwave system that uses microwaves to dry the sieves. The imposition of microwaves heats up the sieves and causes the evaporation of the water molecules therefrom. The microwave signal strength and duration are determined based on calculations for removing the moisture and can be based on the volume of activated alumina. For example, the larger the volume of activated alumina, the longer the duration of the drying and/or the higher the power of the microwave may be required.

Other embodiments may be utilized for the moisture removal system, wherein other usable systems include operations for removing moisture from the activated alumina. For example, one embodiment may be a heating unit that uses heat to cause the moisture evaporation. Other types of dryers can include direct rotary drying systems, indirect rotary drying systems, catalytic infrared drying systems, bulk drying systems, pressure swing absorption systems, temperature swing absorption systems, aero-flight open chain conveyor drying systems, and, microwave drying systems.

Regardless of the specific implementation, the moisture removal system 142 thereby returns the activated alumina to a state similar or identical to their state prior to insertion in the combination unit 106 by causing the moisture to be removed and/or eradicated from therefrom, thus generating the dried activated alumina.

The analyzer 146 is a moisture analyzing device that is operative to determine the moisture level of mineral slurry passing therethrough. The analyzer 146 may be any suitable type of moisture analysis device recognized by one skilled in the art, such as but not limited to a product by Sabia Inc. that uses a PGNA elemental analysis combined with their proprietary algorithms to measure real time moisture content of a moving stream of mineral slurry on a belt using an integrated analyzer feature contained in their SABIA X1-S Sample Stream Analyzer.

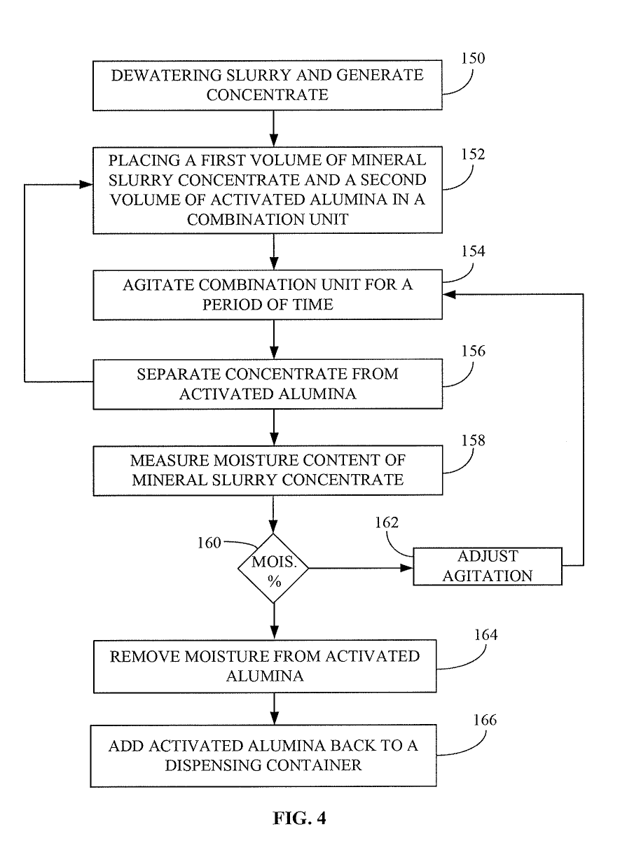

For the sake of brevity, operations of one embodiment of the system 140 are described relative to the flowchart of FIG. 4. FIG. 4 illustrates the steps of one embodiment of drying mineral slurry and including additional processing operations for a continuous slurry drying process.

In the methodology of FIG. 4, a first step, step 150 is dewatering the mineral slurry to expose the mineral elements and generate the mineral slurry concentrate. This step may be performed using known separation techniques, separating slurry moisture from surfactant moisture. For example, the slurry may be passed over grates or sieves having meshing sizes small enough so the mineral elements in the slurry do not pass through, but the slurry moisture does. In one embodiment, for example, the mineral elements in the slurry are passed over screens so the large impurities are separated. The step may screen out 325 mesh to zero and then crush again until all elements are under 325 mesh. The process may use magnets to then separate elements from the slurry. This then creates 60 to 65 percent magnetic slurry, which must then be dewatered to approximately 10 percent moisture by weight to be used to make pellets. The process includes calcification to make the pellets and the pellets are then shipped to plants, where they are then ground up to a finer mixture, such as quarter inch to one millimeter and 1 mm to zero.

In this embodiment, the mineral elements comprising the elements between 325 mesh to zero are provided to the distribution unit 104. It is recognized that the mineral elements are not restricted to a sizing of 325 mesh to zero, but rather can be any other suitable sizing, including being further refined into smaller increments, such as 28 mesh to 100 mm, 100 mm to 200 mm, 200 mm to 325 mm and 325 mm to zero, by way of example.

The next steps of the method of FIG. 4 are, step 152, placing a first volume of mineral elements and a second volume of activated alumina in the combination unit, step 154, agitating the combination unit, and step 156, separating the mineral elements from the activated alumina. These steps may be similar to steps 120, 122 and 124 of FIG. 2.

As illustrated in the system 140 of FIG. 3, the separator 108 separates the activated alumina from the mineral elements such that the separate elements may be further processed separately. Step 158 of the methodology includes measuring the moisture content of the mineral elements using the analyzer 146.

Further illustrated in this embodiment, the system 140 is a continuously flow system such that in normal operations, the method of FIG. 4 concurrently reverts to step 152 for the continued placement of mineral elements and activated alumina into the combination unit.

In drying mineral elements, it is not necessary to completely remove all moisture, but rather drying seeks to achieve a target range of moisture content, as an example, 10 percent. This moisture content then translates into overall moisture content per weight, e.g. tonnage, of mineral material required for further processing of the mineral concentrate into marketable pellets required for the production of steel. It is recognized that in one embodiment, the mineral slurry is further processed to generate filter cakes in accordance with known techniques, whereby the reduction in moisture content in the filter cake is not yet sufficient to allow the production of iron ore pellets. For example, in one embodiment, mineral slurry concentrate may contain 60-65 percent iron ore, where the concentrate, also referred to as filter cake, includes the reduction of moisture to about 25 percent moisture content. The generation of concentrate, filter cake, may be performed using any number of known techniques to remove the excess moisture, including for example vacuum disk filters. This filter cake needs further moisture reduction. In the present embodiment, the drying method and process applies to the further moisture reduction of the filter cake, also referred to as mineral slurry concentrate, using the herein described techniques instead of the more expensive, more time and power consumptive prior art techniques, such as techniques using heat.

Step 160 is a decision step to determine if the moisture content is above or below a predetermined moisture level. By way of example and not meant to be a limiting value, the combination unit 106 may seek a moisture level at 10 percent within a standard deviation range. If the moisture level is above or below that value, step 162 is to adjust the agitation reverting the process back to step 154. Step 162 represents one possible embodiment for adjusting the moisture level, wherein the system 140 is a continuous flow system such that the feedback loop 148 would adjust the combination unit 106 for current drying operations, not the drying of the mineral elements already past the separator 108.

In one embodiment, the combination unit 106 may be a rotational unit including an actuator that controls the rotational speed. Based on the feedback loop 148, this may increase or decrease the speed. For example, if the moisture level is below the desired percentage, this infers that too much moisture is being removed and therefore the amount of contacting engagement between the mineral elements and activated alumina is too long such that the rotational speed is increased. Conversely, if the moisture level is too low, this may indicate the desire to slow down the combination unit 106 to increase the amount of surface engagement time.

In the method of FIG. 4, another step, step 166, is the removal of moisture from the activated alumina. As illustrated in FIG. 3, this may be done using the moisture removal system 142. When the moisture is removed, this generates dried activated alumina 144, which can then be added back to the sieve distribution unit 102. This allows for re-use of the activated alumina for continuous drying operations.

With respect to the feedback loop 148, it is recognized that other modifications may be utilized and the feedback is not expressly limited to the combination unit 106. For example, in one embodiment the activated alumina dispensing unit may include a flow regulator that regulates the volume of activated alumina released into the combination unit 106. The adjustment of the volume of activated alumina may be adjusted to change the moisture level of the mineral elements, such as if there are more activated alumina, it may provide for reducing more moisture and vice versa. In another embodiment, the feedback loop may provide for adjustment of the dispensing rate of mineral elements from the distribution device 104.

Regarding the activated alumina, hydratable polymeric materials or compositions comprising one or more hydratable polymers may be employed to reduce the moisture content of mineral elements (e.g., polyacrylate or carboxymethyl cellulose/polyester particles/beads). In one embodiment the hydratable polymeric materials is polyacrylate (e.g., a sodium salt of polyacrylic acid). Polyacrylate polymers are the superabsorbents employed in a variety of commercial products such as in baby's diapers, because of their ability to absorb up to 400% of their weight in water.

Thereby, the various embodiments provide methods and systems for drying mineral elements extracted from the mineral slurry concentrate. The drying utilizes activated alumina.

FIGS. 1 through 4 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

What is claimed is:

1. A method for processing mineral slurry comprising:
receiving a mineral slurry concentrate having mineral components below a threshold size combined in a solution having a moisture content;
combining a first volume of the mineral slurry concentrate with a second volume of activated alumina;
reducing the moisture content of the first volume of mineral slurry concentrate through contacting engagement with activated alumina such that moisture content of the first volume of mineral slurry concentrate is reduced by the transference of water molecules into the activated alumina;
separating the second volume of activated alumina from the first volume of mineral slurry concentrate; and
discharging the first volume of mineral slurry concentrate, having the moisture content reduced therein, for further processing.

2. The method of claim 1, wherein the mineral slurry concentrate includes iron ore.

3. The method of claim 1, wherein the contacting engagement includes agitating the mineral slurry concentrate with the activated alumina.

4. The method of claim 1, wherein the contacting engagement of the activated alumina and mineral slurry concentrate is for a first period of time.

5. The method of claim 4 further comprising:
adjusting the moisture content of the mineral slurry concentrate by adjusting the first period of time.

6. The method of claim 3, wherein the drying includes adjusting the second volume of activated alumina for contacting engagement.

7. The method of claim 1 further comprising:
separating the second volume of activated alumina from the first volume of mineral slurry concentrate using at least one of: a screening process and a magnetism process.

8. A system for processing mineral slurry comprising:
a receiving device operative to receive a mineral slurry concentrate having mineral components below a threshold size combined in a solution, the slurry having a moisture content;
a combination unit for holding a first volume of the mineral slurry concentrate and a second volume of activated alumina;
a distribution unit for placing the first volume of mineral slurry concentrate in the combination unit;
a activated alumina distribution unit for placing the second volume of activated alumina in the combination unit, such that the moisture content of the mineral slurry concentrate is reduced by the transference of water molecules into activated alumina;
a separation device for separating the activated alumina from the mineral slurry concentrate; and
a discharge device for discharging the first volume of mineral slurry concentrate, having the moisture content reduced therein, for further processing.

9. The system of claim 8, wherein the mineral slurry concentrate includes iron ore.

10. The system of claim 8 further comprising:
an agitation device for agitating the combination unit and thereby agitating the mineral slurry concentrate and activated alumina when in contacting engagement.

11. The system of claim 10 further comprising:
a timing device for timing the contact engagement of the activated alumina and mineral slurry concentrate to reduce the moisture content of the mineral slurry concentrate to a first moisture level based on the engagement of the mineral slurry concentrate and activated alumina.

12. The system of claim 8 further comprising:
the distribution unit including a distribution adjuster for adjusting the first volume of activated alumina in the combination unit.

13. The system of claim 8 further comprising:
the activated alumina distribution unit including a distribution adjuster for adjusting the second volume of activated alumina in the combination unit.

14. The system of claim 8 further comprising:
a separation unit operative to separate the second volume of activated alumina from the first volume of mineral slurry concentrate using at least one of: a screening process and a magnetism process.

15. A method for drying iron ore comprising:
combining a first volume of an iron ore slurry with a second volume of activated alumina;
reducing the moisture content of the first volume of iron ore slurry through contacting engagement with activated alumina to reduce the moisture content of the first volume of iron ore slurry; and
separating the second volume of activated alumina from the first volume of iron ore slurry.

16. The method of claim 15, further comprising:
agitating the iron ore slurry with the activated alumina.

17. The method of claim 16, further comprising:
discharging the first volume of mineral slurry concentrate, having the moisture content reduced therein, for further processing.

18. A system for drying iron ore comprising:
a combination unit for holding a first volume of iron ore slurry and a second volume of activated alumina;
a distribution unit for placing the first volume of iron ore slurry in the combination unit;
a activated alumina distribution unit for placing the second volume of activated alumina in the combination unit to reduce the moisture content of the first volume of iron ore slurry; and
a separation device for separating the activated alumina from the mineral slurry concentrate.

19. The system of claim 18 further comprising:
an agitation device for agitating the combination unit and thereby agitating the iron ore slurry and activated alumina when in contacting engagement.

20. The system of claim 18 further comprising:
a discharge device for discharging the first volume of iron ore slurry, having the moisture content reduced therein, for further processing.
